(19) United States
(12) Patent Application Publication
(10) Pub. No.: US 2025/0266621 A1
(43) Pub. Date: Aug. 21, 2025

(54) TRANSMISSIVE SURFACE WITH ENERGY-ATTENUATING COATING

(71) Applicant: QUALCOMM Incorporated, San Diego, CA (US)

(72) Inventors: Jorge FABREGA SANCHEZ, San Diego, CA (US); Allen Minh-Triet TRAN, Rancho Santa Fe, CA (US); Tao LUO, San Diego, CA (US)

(21) Appl. No.: 19/049,755

(22) Filed: Feb. 10, 2025

Related U.S. Application Data
(60) Provisional application No. 63/554,040, filed on Feb. 15, 2024.

(51) Int. Cl. H01Q 17/00

(52) U.S. Cl. CPC H01Q 17/00

(57) ABSTRACT

An transmissive surface and a method for forming a transmissive surface are described. The transmissive surface may include a substrate and an energy-attenuating coating located on the substrate. The energy-attenuating coating may cause an attenuation of radio frequency signals that propagate through the transmissive surface. A portion of the energy-attenuating coating may include a pattern of cells that provides a reduced attenuation of radio frequency signals that pass through the portion of the energy-attenuating coating relative to other portions of the energy-attenuating coating outside of the pattern of cells. The pattern of cells may be consistent along a first direction and varied across a second direction perpendicular to the first direction such that a same phase adjustment of a propagated radio frequency signal is applied along the first direction and a varying phase adjustment is applied along the second direction.

### CROSS REFERENCE

The present Application for Patent claims the benefit of U.S. Provisional Patent Application No. 63/554,040 by FABREGA SANCHEZ et al., entitled “TRANSMISSIVE SURFACE WITH ENERGY-ATTENUATING COATED GLASS,” filed Feb. 15, 2024, assigned to the assignee hereof, and expressly incorporated by reference herein.

### FIELD OF TECHNOLOGY

The following relates to an energy-attenuating surface, for example to etched portions of an energy-attenuating coating on a substrate of a laminate that provide a transmissive surface on the substrate.

### BACKGROUND

In some cases, a substrate, such as a glass window, may include a layer of metal that may act as an energy-attenuating coating. The energy-attenuating coating may permit visible light to propagate through the substrate, but block one or more other wave types, such as infrared, ultraviolet, radio waves, or any combination thereof.

### SUMMARY

The described techniques relate to improved methods, systems, devices, and apparatuses that support transmissive surfaces, for example that are associated with energy-attenuating coatings.

An transmissive surface is described. The transmissive surface may include an energy-attenuating coating provided on a substrate, the energy-attenuating coating causing an attenuation of radio frequency signals that propagate through the transmissive surface, where a portion of the energy-attenuating coating is provided with a pattern of cells with openings that reduces attenuation of radio frequency signals propagating through the portion relative to another portion of the energy-attenuating coating that is provided without openings, and where, and the pattern of cells is provided along a first direction with cells having uniform sizes and shapes and provided along a second direction perpendicular to the first direction with cells having varying sizes or shapes such that a propagated radio frequency signal experiences a varying phase adjustment across the pattern of cells in the second direction.

In some examples of the transmissive surface, the pattern of cells includes a row of cells duplicated along the first direction, the row including a set of multiple cells having varying outline widths, varying central patch sizes, or both of the energy-attenuating coating across the row, where the outline widths, the central patch sizes, or both of the energy-attenuating coating increase at a center of the row relative to an edge of the row.

In some examples of the transmissive surface, the pattern of cells includes a row of cells duplicated along the first direction, the row including one or more first groups of cells having a first outline width, a first central patch size, or both and one or more second groups of cells having a second outline width smaller than the first outline width, a second central patch size smaller than the first central patch size, or both, where respective groups of cells of the one or more first groups of cells and the one or more second groups of cells alternate across the row, and where the pattern of cells may be symmetrical to a center of the row.

In some examples of the transmissive surface, each cell of the pattern of cells includes an outline of the energy-attenuating coating, a central patch of the energy-attenuating coating, or both.

In some examples of the transmissive surface, a size of the central patch of the energy-attenuating coating may be equal to or less than half of a wavelength associated with the radio frequency signals that propagate through the transmissive surface.

In some examples of the transmissive surface, a width of an opening between the outline of the energy-attenuating coating and the central patch of the energy-attenuating coating may be non-uniform across the pattern in the second direction.

In some examples of the transmissive surface, the width of the opening between the outline of the energy-attenuating coating and the central patch of the energy-attenuating coating may be between approximately 3/160 and 15/160 of a wavelength associated with an incident beam of the radio frequency signals that propagate through the transmissive surface.

In some examples of the transmissive surface, a size of the central patch of the energy-attenuating coating may be correlated to a transmission phase of the radio frequency signals that propagate through the transmissive surface.

In some examples of the transmissive surface, a total width and a total height of the portion including the pattern of cells may be 4 or more times larger than a wavelength associated with the radio frequency signals that propagate through the transmissive surface.

In some examples of the transmissive surface, the pattern of cells may be selected such that the radio frequency signals that propagate through the transmissive surface may have the reduced attenuation at an identified location within a structure that incorporates the transmissive surface.

In some examples of the transmissive surface, the substrate includes a first substrate of a set of multiple substrates and the energy-attenuating coating includes a first energy-attenuating coating of a set of multiple energy-attenuating coatings corresponding to each substrate of the set of multiple substrates.

In some examples of the transmissive surface, two or more patterned energy-attenuating coatings may be located on a same side of the substrate.

Some examples of the transmissive surface may further include a second energy-attenuating coating located on a side of the substrate opposite the first energy-attenuating coating.

In some examples of the transmissive surface, the transmissive surface may be separate from an entity from which the radio frequency signals may be transmitted.

In some examples of the transmissive surface, the pattern of cells provides a radiation beam shape of the radio frequency signals that propagate through the transmissive surface, a radiation beam position of the radio frequency signals that propagate through the transmissive surface, or both, associated with a first shape, the first shape being different than a second shape associated with a uniform pattern of cells in the energy-attenuating coating.

A method for forming a transmissive surface is described. The method may include forming a pattern of cells with openings in a portion of an energy-attenuating coating on a substrate, wherein the pattern of cells with openings reduces attenuation of radio frequency signals propagating through the portion relative to another portion of the energy-attenuating coating that is provided without openings, where the pattern of cells is provided along a first direction with cells having uniform sizes and shapes and provided along a second direction perpendicular to the first direction with cells having varying sizes or shapes such that a propagated radio frequency signal experiences varying phase adjustment across the pattern of cells in the second direction.

In some examples of the method, forming the pattern of cells includes etching the portion of the energy-attenuating coating to remove sections of the energy-attenuating coating according to the pattern of cells.

In some examples of the method, the pattern of cells includes a row of cells duplicated along the first direction, the row pattern including a plurality of cells having varying outline widths, varying central patch sizes, or both of the energy-attenuating coating along the row, where the outline widths, the central patch sizes, or both of the energy-attenuating coating increases at a center of the row relative to an edge of the row.

In some examples of the method, the pattern of cells includes a row of cells duplicated along the first direction, the row including one or more first groups of cells having a first outline width, a first central patch size, or both, and one or more second groups of cells having a second outline width smaller than the first outline width, a second central patch size smaller than the first central patch size, or both, where respective groups of cells of the one or more first groups of cells and the one or more second groups of cells alternate across the row, and where the pattern of cells is symmetrical to a center of the row.

In some examples of the method, each cell of the pattern of cells includes an outline of the energy-attenuating coating, a central patch of the energy-attenuating coating, or both.

In some examples of the method, a size of the central patch of the energy-attenuating coating in the one or more first groups and the one or more second groups is equal to or less than half of a wavelength associated with the radio frequency signals that propagate through the transmissive surface.

In some examples of the method, a width of an opening between the outline of the energy-attenuating coating and the central patch of the energy-attenuating coating is non-uniform across the pattern in the second direction.

In some examples of the method, the width of the opening between the outline of the energy-attenuating coating and the central patch of energy-attenuating coating in the one or more first groups and the one or more second groups is between approximately 3/160 and 15/160 of a wavelength associated with an incident beam of the radio frequency signals that propagate through the transmissive surface.

In some examples of the method, a size of the central patch of the energy-attenuating coating is correlated to a transmission phase of the radio frequency signals that propagate through the transmissive surface.

In some examples of the method, a total width and a total height of the portion including the pattern of cells is 4 or more times larger than a wavelength associated with the radio frequency signals that propagate through the transmissive surface.

In some examples of the method, the pattern of cells is selected such that the radio frequency signals that propagate through the transmissive surface has the reduced attenuation at a location within a structure that incorporates the transmissive surface.

In some examples of the method, the substrate includes a first substrate of a plurality of substrates, and the energy-attenuating coating includes a first energy-attenuating coating of a plurality of energy-attenuating coatings corresponding to each substrate of the plurality of substrates.

In some examples of the method, two or more patterned energy-attenuating coatings are located on a same side of the substrate.

In some examples of the method, the energy-attenuating coating includes a first energy-attenuating coating of a plurality of energy-attenuating coatings, the method further including providing a second energy-attenuating coating located on a side of the substrate opposite the first energy-attenuating coating.

In some examples of the method, the transmissive surface is separate from an entity from which the radio frequency signals are transmitted.

In some examples of the method, the pattern of cells provides a radiation beam shape of the radio frequency signals that propagate through the transmissive surface, a radiation beam position of the radio frequency signals that propagate through the transmissive surface, or both, associated with a first shape, the first shape being different than a second shape associated with a uniform pattern of cells in the energy-attenuating coating.

### BRIEF DESCRIPTION OF THE DRAWINGS

FIG. 1 shows an example of a wireless communications system with one or more transmissive surfaces having an energy-attenuating coating in accordance with one or more aspects of the present disclosure.

FIG. 2 shows an example of a transmissive surface with energy-attenuating coating in accordance with one or more aspects of the present disclosure.

FIG. 3 shows an example of a transmissive surface with an energy-attenuating coating in accordance with one or more aspects of the present disclosure.

FIG. 4 shows an example of a plot of a signal that may pass through a transmissive surface with an energy-attenuating coating in accordance with one or more aspects of the present disclosure.

FIG. 5 shows an example of a non-uniform pattern diagram of a transmissive surface with an energy-attenuating coating in accordance with one or more aspects of the present disclosure.

FIGS. 6 and 7 show examples of plots related to transmissive surfaces with energy-attenuating coatings in accordance with one or more aspects of the present disclosure.

FIG. 8 shows another example of a non-uniform pattern diagram of a transmissive surface with an energy-attenuating coating in accordance with one or more aspects of the present disclosure.

FIGS. 9 and 10 show examples of plots of signals that may pass through transmissive surfaces with energy-attenuating coatings in accordance with one or more aspects of the present disclosure.

FIG. 11 shows another example of a non-uniform pattern diagram of a transmissive surface with an energy-attenuating coating in accordance with one or more aspects of the present disclosure.

FIGS. 12 and 13 show flowcharts illustrating a method of fabricating a transmissive surface with energy-attenuating coating in accordance with one or more aspects of the present disclosure.

### DETAILED DESCRIPTION

An energy-attenuating laminate, such as an energy-attenuating window, may improve an energy efficiency of an associated space, such as a structure in which an energy-attenuating window with energy-attenuating construction glass is installed. For example, the energy-attenuating laminate may include one or multiple layers of metal that provide an energy-attenuating coating, such as one or more layers of silver, tin, or zinc. The energy-attenuating coating may permit visible light to pass through, but deflect ultraviolet rays, infrared light, or both. Deflecting the ultraviolet rays and infrared light may reduce heat loss within the structure. However, the energy-attenuating laminate, such as energy-attenuating construction glass, may prevent a radio frequency signal from penetrating the structure. For example, energy-attenuating construction glass may prevent radio frequency signals from penetrating inside or outside of structures due to (e.g., based on) a presence of the layer(s) of metal on the glass surface. In other words, a substrate may include the layer(s) of metal, such as the energy-attenuating coating. In some examples, a penetration of radio frequency signals through the energy-attenuating laminate may be improved by implementing a uniform cut-out pattern on a portion of the energy-attenuating coating. For example, a portion of the energy-attenuating coating may be etched (e.g., with a laser) to include the uniform cut-out pattern, where the etched portion may allow the radio frequency signal to pass through. In other words, a uniform cut-out pattern may be etched on a portion of the energy-attenuating metal layer by a lasering process. However, the radio frequency signal propagated through the energy-attenuating laminate with such uniform patterns may still experience radio signal loss and/or result in limited coverage when signals are transmitted from outside the structure to inside, or vice versa.

In accordance with various aspects discussed herein, non-uniform patterns in an energy-attenuating coating may adjust a radiation beam shape, a radiation beam position, a radiation beam direction, individually or in combination. For example, a non-uniform etching pattern may include a pattern of cells that is consistent along a first direction and varied across a second direction perpendicular to the first direction. That is, the pattern of cells may include “stripes” of cells having energy-attenuating material removed. Based on the striped pattern of cells, a same phase adjustment of a propagated radio frequency signal may be applied along a direction where the pattern is varied (e.g., along the second direction). In some examples, the pattern of cells may include multiple cells having an outline of energy-attenuating coating and a central patch of energy-attenuating coating. Each of the multiple cells may have a different outline size, central patch size, or both. In other words, a width of an opening between the outline and the central patch may be different among cells of the non-uniform etching pattern. In some aspects, the non-uniform etching pattern may support shaping of radio frequency signals propagating through the energy-attenuating laminate. For example, the radio frequency signal may be associated with a plane wave before propagating through the energy-attenuating laminate and a wide beam after propagating through the energy-attenuating laminate.

Aspects of the disclosure are initially described in the context of transmissive surfaces. The transmissive surface may include an energy-attenuating coating, and may be produced as a laminate. The energy-attenuating coating may be etched to form patterns as described herein. In other examples, (energy-attenuating) patterns may be formed in the transmissive surface through means other than etching. For example, an energy-attenuating coating may be applied as a pattern instead of being etched away, or the transmissive surface may be manufactured without a coating in such a way that the transmissive properties of the surface vary throughout the surface to form patterns that selectively attenuate energy and/or adjust a phase thereof. Further, the transmissive surface need not be produced as a laminate, but may have any configuration which includes energy-attenuating patterns as described herein. Certain configurations are described below which include an energy-attenuating coating for ease of description, but it will be understood that other configurations of transmissive surface (with a varying pattern of energy attenuation) may additionally or alternatively be implemented.

Aspects of the disclosure are also described in the context of non-uniform pattern diagrams and plots. Aspects of the disclosure are further illustrated by and described with reference to flowcharts that relate to transmissive surface with energy-attenuating coated glass.

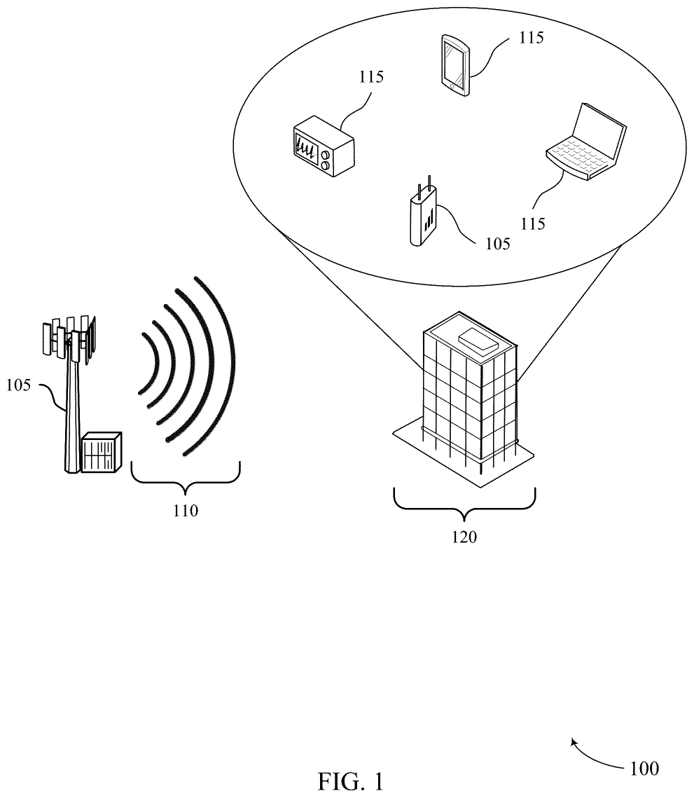

FIG. 1 shows an example of a wireless communications system 100 in which one or more devices communicate through a transmissive surface with an energy-attenuating coating in accordance with one or more aspects of the present disclosure. The wireless communications system 100 may include one or more devices, such as one or more network devices (e.g., network entities 105) and one or more user equipments (UEs) 115. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) (e.g., a radio frequency (RF) access link).

The UEs 115 may be dispersed throughout a coverage area of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

One or more of the network entities 105 or network equipment described herein may include or may be referred to as a base station (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station) may be implemented in an aggregated (e.g., monolithic, standalone) base station architecture, which may be configured to utilize a protocol stack that is physically or logically integrated within one network entity (e.g., a network entity 105 or a single RAN node, such as a base station).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays or customer premises equipment (CPE), as well as the network entities 105 and the network equipment including macro eNBs or gNBs, small cell eNBs or gNBs, or relay base stations, among other examples, as shown in FIG. 1.

As described herein, the network entity 105 may transmit radio frequency signals to one or more of the UEs 115 or the network entity 105 in a building 120. The radio frequency signals may be associated with a radio frequency wave 110. The radio frequency wave 110 may, in some cases, attenuate, reflect, or scatter based on an interaction with the building. For example, an amplitude of the radio frequency wave 110 may decrease as the radio frequency wave 110 propagates through the building 120.

In some cases, one or more windows of the building 120 may include energy-attenuating glass. The term energy-attenuating (e.g., low-e), as described herein, may refer to an emissivity value of approximately 0.05 or lower. For example, energy-attenuating coating may be applied to a glass substrate to improve an emissivity value associated with the glass (e.g., alone) of approximately 0.84 to the 0.05 or lower associated with an energy-attenuating coating. In some examples, the energy-attenuating coating may block or substantially reduce the signal strength of the radio frequency wave 110 propagating through the building 120. That is, one or more of the UEs 115 or the network entity 105 in the building may not be able to receive the radio frequency wave 110 from the network entity 105 due to the energy-attenuating coating. The energy-attenuating coating may be referred to as a low-emissivity (e.g., “low-e”) coating. While the example of FIG. 1 illustrates a building with energy-attenuating coated glass, various techniques as discussed herein may be used for transmissive surfaces in other forms and/or in other settings, such as vehicles, aircraft, and the like.

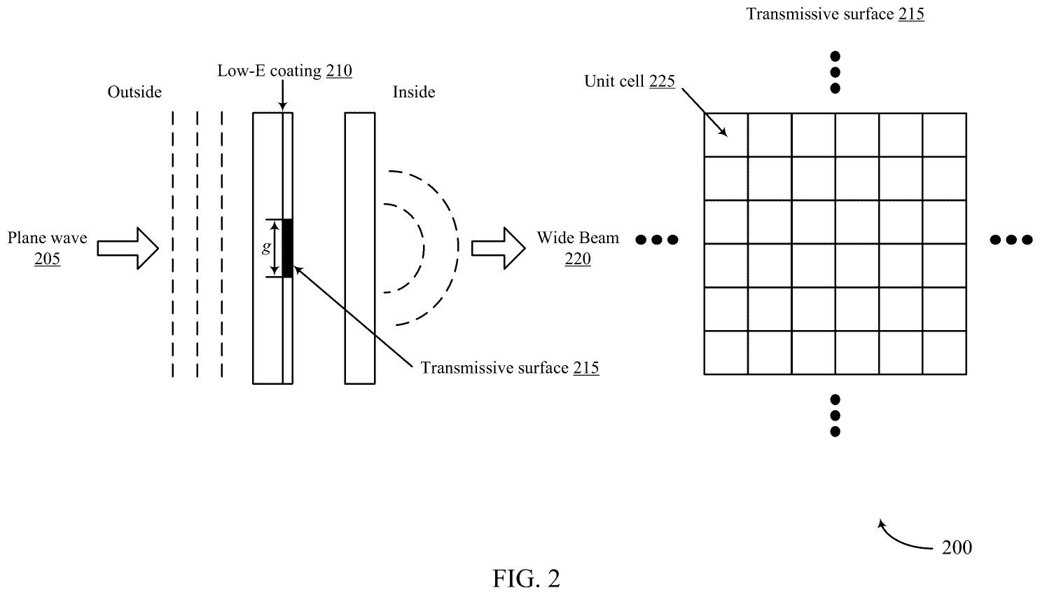

FIG. 2 shows an example of a transmissive surface 200 with an energy-attenuating coating in accordance with one or more aspects of the present disclosure. In some cases, an opening of an energy-attenuating coating 210 may be associated with a diffraction and narrow coverage. For example, a plane wave 205 of a radio frequency signal (e.g., from a network entity) outside of a building having a surface with the energy-attenuating coating 210 and the opening may experience diffraction through the opening of the energy-attenuating coating 210. That is, the plane wave 205 of the radio frequency signal may penetrate the building through the opening. The diffracted beam may produce (e.g., be associated with) a narrow coverage inside the building. For example, the diffracted beam may produce the narrow coverage based on a width of the opening g being much greater than a wavelength associated with the radio frequency signal (e.g., g >>λ)). The diffracted beam may, based on the width of the opening relative to the wavelength, produce the narrow coverage without directionality or beamwidth control. In other words, the uniform pattern for the energy-attenuating coating 210 may produce the narrow coverage (e.g., a narrow beam) with a low level of control related to a radiation beam shape, a radiation beam position or direction, or both propagating through the laminate.

Additionally, or alternatively, the energy-attenuating coating 210 may include a uniform pattern. For example, the uniform pattern may be etched into the energy-attenuating coating 210 in multiple rows and columns. That is, the uniform etching pattern may produce an array of uniform portions of the energy-attenuating coating 210 with uniform gaps therebetween. The uniform etching pattern may be associated with the low level of control related to the radiation beam shape, the radiation beam position or direction, or both. Further, the uniform etching pattern may produce a radio signal having a loss (e.g., a decibel loss).

In some examples, pattern synthesis techniques may be used to provide an energy-attenuating pattern on a substrate that causes an attenuation of radio frequency signals that propagate through the transmissive surface. Pattern synthesis techniques may be applied to control a radiation beam shape, beam pointing position or direction, or both for signals that pass through the transmissive surface. For example, a pattern of the energy-attenuating coating 210 may support a widening of an incoming beam. The pattern of the energy-attenuating coating 210 may be determined in order to support increased levels of control related to the beam shape and/or the beam pointing position (e.g., relative to the uniform pattern). For example, the pattern may be based on quadratic-phase excitation, random phase optimized excitation, or both. The pattern of the energy-attenuating coating 210 may be understood as an array including multiple elements. For example, the quadratic-phase excitation may be applied to the elements of the array in order to produce a wide beam 220. Additionally, or alternatively, the random phase optimized excitation may be applied to the elements of the array to shape the beam (e.g., to produce the wide beam 220). That is, random phases may be applied to the elements of the array.

As described herein, a transmissive surface 215 (e.g., of a glass or plastic) structure may support control of a shape and directionality of a radio frequency beam penetrating a building. For example, a shape and directionality of a radio frequency signal may be controlled by determining a phase distribution of a transmission response across an opening. In other words, determination of a non-uniform etching pattern to be applied to the transmissive surface 215 may support the control of the shape and directionality of the radio frequency signal. For example, the non-uniform etching pattern may refer to different patterns applied to unit cells 225 of the transmissive surface 215. Control of the shape and directionality of the radio signal via the non-uniform pattern applied to the transmissive surface 215 may support improved reception at devices within the building. Note that the view (e.g., a front view) of the transmissive surface 215 (e.g., on the right side of FIG. 2) is perpendicular to the view (e.g., a side view) of the transmissive surface on the left side of FIG. 2

In some examples, the transmissive surface 215 may be a single layer. For example, the transmissive surface 215 may be a single layer formed by etching a pattern on an energy-attenuating coating 210 layer or by adding a conductive pattern on another surface. Additionally, or alternatively, the transmissive surface 215 may include multiple layers of the energy-attenuating coating 210. For example, the energy-attenuating coating 210 may be applied to an outer surface of a laminate and an inner surface of the laminate, or the energy-attenuating coating 210 may be stacked on a same surface of the laminate. That is, a first layer of the energy-attenuating coating 210 may be applied and etched, then a second layer of the energy-attenuating coating 210 may be applied and etched, and so on. In some examples, a spacing may be applied between the first layer and the second layer (e.g., another pane of glass, a transparent dielectric film, etc.). The application of multiple layers of the energy-attenuating coating 210 may be associated with a greater phase change between an incoming beam and an outgoing beam from the laminate compared to the single layer of the energy-attenuating coating 210. That is, an effect of a single layer of the energy-attenuating coating 210 having the non-uniform etched pattern may be multiplied when the layers are stacked such that a phase change may be large relative to the single layer. In other words, multiple layers may support better transmission phase and amplitude control than a single layer. Additionally, or alternatively, one or more additional layers (e.g., metallization layers) on a different substrate (e.g., a non-glass substrate) may be stacked on top of the energy-attenuating coating 210. In other words, the multiple layers may be associated with a wider beam than the single layer, but both the multiple layers and the single layer having the non-uniform pattern may be associated with the wider beam than the uniform pattern.

In other words, the substrate may include a first substrate of multiple substrates, and the energy-attenuating coating 210 may include a first energy-attenuating coating 210 of multiple energy-attenuating coatings corresponding to each substrate of the multiple substrates and/or multiple surfaces of the substrate(s). In some examples, two or more patterned energy-attenuating coatings are located on a same side of the substrate. Additionally, or alternatively, a second energy-attenuating coating may be located on a side of the substrate opposite the first energy-attenuating coating.

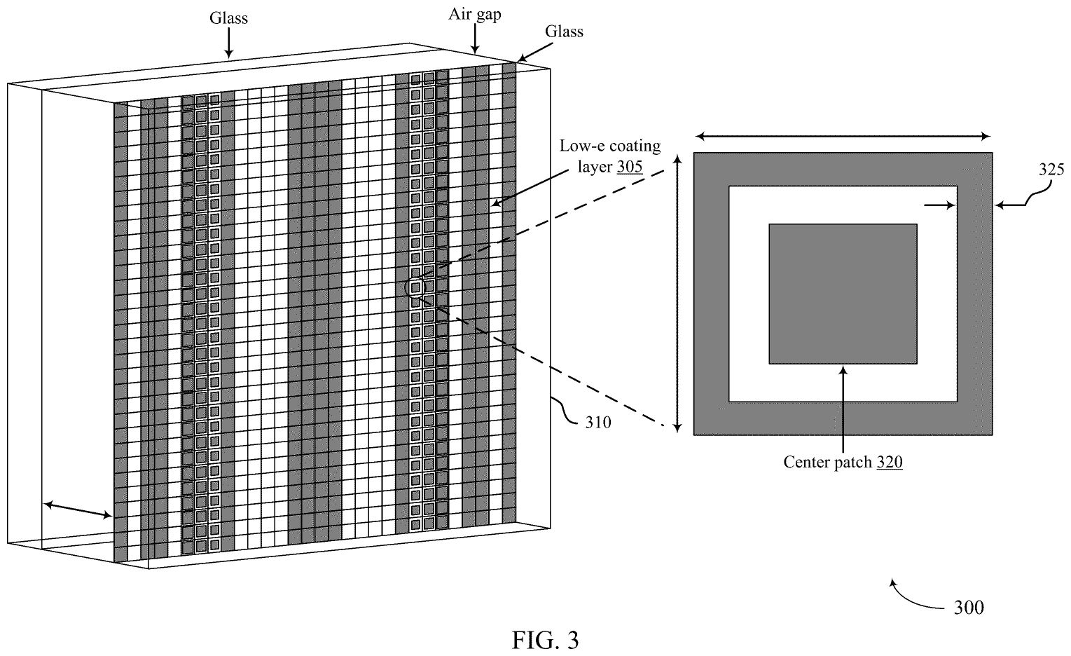

FIG. 3 shows an example of a transmissive surface with an energy-attenuating coating 300 in accordance with one or more aspects of the present disclosure. In the example of FIG. 3, a transmissive surface with the energy-attenuating coating may be etched according to a non-uniform pattern. In some examples, the transmissive surface may be etched according to a frequency of an incoming signal, such as sub-6 GHz or 28 GHz. A dark portion of the pattern shown in the example of FIG. 3 may represent the energy-attenuating coating, while a light portion of the pattern may represent openings in the energy-attenuating coating exposing the glass 310 (which may be an example of a substrate, such as a glass substrate). That is, on an energy-attenuating coating 305 layer, the light portion may represent a portion of the energy-attenuating coating which has been etched away. It is noted that although various examples discussed herein refer to a glass substrate, other materials may be used as the substrate of the energy-attenuating coating such as, for example, acrylic, plexiglass, or polycarbonate, and such other types of substrates are within the scope of this disclosure.

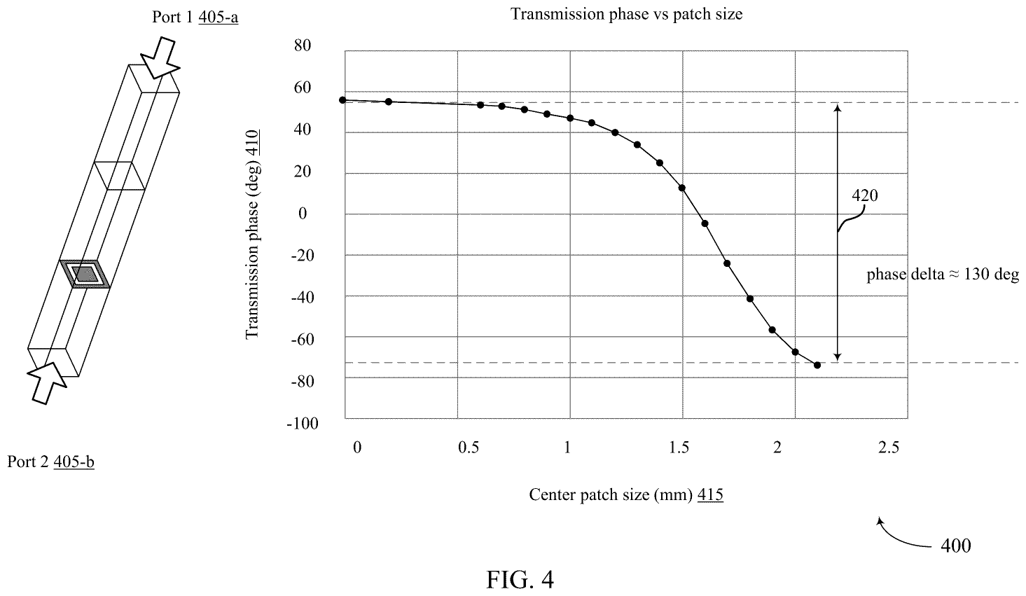

In some aspects, the non-uniform pattern may include multiple cells of a fixed size. Each cell may include an outline 325 and/or a central patch 320 of the energy-attenuating coating and an opening therebetween. That is, a laser may be used to etch away a square ring forming an opening in each cell, where a size of the central patch 320 and/or a width of the opening in form of the square ring varies according to the non-uniform pattern (e.g., the width of the opening may be between 3/160 and 15/160 of the wavelength of an incident beam, the central patch 320 may be equal to or less than half of the wavelength, etc.). For example, the opening in form of the square ring may refer to an area between the outline 325 and the central patch 320. A size of the central patch 320, a width of the outline 325, or both may be associated with a transmission phase of the outgoing signal. A variation of the size of the central patch 320, the width of the outline 325, or both may be associated with a variation of a transmission phase of the outgoing signal. A relationship between the transmission phase and the central patch size may be described in greater detail elsewhere herein, including with reference to FIG. 4. In some examples, the energy-attenuating coating of a cell may be removed entirely for the cell such that no outline and/or central patch is present for the cell.

The non-uniform pattern may include a row pattern which is repeated along a vertical dimension (e.g., first direction) of the energy-attenuating coating 305 layer. For example, the row pattern may be repeated such that each cell along a column of the non-uniform pattern may be uniform. In other words, the pattern may vary in the horizontal dimension (e.g., second direction) but not in the vertical dimension (e.g., perpendicular to the horizontal dimension). As an example, a first cell of a row of the non-uniform pattern may have a central patch size α, and the cells above and below the first cell may also have the central patch size α. The row pattern may be repeated (e.g., rather than a column pattern and/or variation in the vertical dimension) to support the widening of radio frequency signals horizontally, providing increased coverage of the radio frequency signals in the interior of the transmissive surface. Alternatively, the non-uniform pattern may be used to support widening of radio frequency signals vertically in examples in which a column pattern is repeated along a horizontal dimension.

In some examples, the non-uniform pattern may be determined in order to support an energy efficiency of a building, car, train, bus, or the like having the transmissive surface with the energy-attenuating coated glass. For example, the non-uniform pattern may be based on meeting an energy efficiency threshold and a level of control of a shape and/or directionality of a radio frequency beam penetrating the transmissive surface. In other words, the non-uniform pattern may be determined such that a minimal amount of the energy-attenuating coating may be etched away to produce the wide beam. As an example, a portion (e.g., rather than an entirety) of the energy-attenuating coating may be etched to support the propagation of radio frequency signals. The portion, as an example, may be a square with a width of approximately 30 mm, 84 mm, 120 mm, or other widths therebetween. Additionally, or alternatively, the pattern may be rectangular, among other shapes. That is, while the portion may be illustrated in the example of FIG. 3 as being a square, the portion of the attenuating coating which is etched may be in one or more alternative shapes.

The energy-attenuating coating 305 located on the glass 310 substrate may cause an attenuation of radio frequency signals propagating through the energy-attenuating glass laminate. A portion of the energy-attenuating coating 305 may include a pattern of cells that reduces attenuation of radio frequency signals propagating through the portion of the energy-attenuating coating 305 relative to another portion of the energy-attenuating coating 305 that is provided without openings. The pattern of cells may be provided along a first direction (e.g., vertically) with cells having uniform sizes and shapes and provided along a second direction (e.g., horizontally) perpendicular to the first direction with cells having varying sizes and shapes such that a propagated radio frequency signal experiences a varying phase adjustment across the pattern of cells in the second direction. Additionally, or alternatively, a same amplitude (e.g., a same attenuation in accordance with a same amount of energy-attenuating coating per cell) variation may be applied along the second direction. That is, the pattern of cells may support phase variations, amplitude variations, or both. In some examples, each cell of the pattern of cells may include an outline 325 of the energy-attenuating coating 305 and a central patch 320 of the energy-attenuating coating. In other examples, one or more of the cells includes only an outline 325, only a central patch 320, or no energy-attenuating coating (e.g., neither an outline 325 nor a central patch 320). A width of an opening between the outline 325 of the energy-attenuating coating 305 and the central patch 320 of the energy-attenuating coating 305 (and/or the lack of the outline 325 and/or the central patch 320) is non-uniform across the pattern of cells. The width of the opening may control the phase, the amplitude, or both of the propagated radio frequency signal. For example, a smaller width may cause more attenuation of the signal and a phase change compared to a larger width. In some examples, the pattern of cells may provide a radiation beam shape of the radio frequency signals that propagate through the energy-attenuating glass laminate, a radiation beam position of the radio frequency signals that propagate through the energy-attenuating glass laminate, or both associated with a first shape. The first shape may be different than a second shape associated with a second pattern of cells having uniform gaps in the energy-attenuating coating 305.

In some examples, the width of the opening between the outline 325 of the energy-attenuating coating and the central patch 320 of the energy-attenuating coating 305 may be between approximately 3/160 and 15/160 of a wavelength associated with an incident beam of the radio frequency signals that propagate through the energy-attenuating glass laminate. Additionally, or alternatively, a total width and a total height of the portion including the pattern of cells may be approximately 8 times larger than a wavelength in some examples (e.g., for 30×30 cells having a total dimension of approximately 84×84 mm at 28 GHz) or 11 times larger than a wavelength in some other examples (e.g., for 40×40 unit cells having a total dimension of approximately 120×120 mm at 28 GHz) compared to a wavelength associated with an incident beam of the radio frequency signals that propagate through the energy-attenuating glass laminate. In other examples, the number cells in the vertical direction may be different than the number of cells in the horizontal direction, and/or one or more rows or columns may have a different number of cells than other rows or columns. While the cell, outline 325, and central patch 320 are all illustrated as being approximately square, other shapes are possible. For example, one or more of these elements may be rectangular, circular, elliptical, star-shaped, hexagonal, octagonal, etc. Further, the size and shape of the cells may vary across the pattern. In other examples, the size and shapes of the cells are the same within each pattern.

The pattern of cells may be selected to provide the first radiation beam shape such that a radiation beam of the radio frequency signals that propagate through the energy-attenuating glass laminate has the reduced attenuation at a location within a structure that incorporates the energy-attenuating glass laminate.

FIG. 4 shows an example of a plot 400 of a signal that may pass through a transmissive surface with an energy-attenuating coating in accordance with one or more aspects of the present disclosure. The plot shown in the example of FIG. 4 may illustrate a relationship between a transmission phase 410 and a size of a central patch 415. For example, the size of the central patch 415 may refer to a central patch of a cell of a non-uniform etching pattern, such as the cell or non-uniform etching pattern having an outline 325 as described with reference to FIG. 3. An increasing central patch size may be associated with a greater change in a transmission phase between an incoming radio frequency wave and an outgoing radio frequency wave of transmissive surface having an energy-attenuating coating with the non-uniform etching pattern. In other words, a size of the central patch of the energy-attenuating coating may be correlated to a transmission phase 410 of the radio frequency signals that propagate through the energy-attenuating laminate. For example, the change in the transmission phase shown in a range 420 between the dotted lines in the example of the plot on FIG. 4 may refer to a change in the transmission phase 410 between the radio frequency wave between a first port 405-a (e.g., port 1) and a second port 405-b (e.g., port 2), where the first port refers to an exterior of the transmissive surface (e.g., an exterior of a building, car, train, bus, etc.) and the second port refers to an interior of the transmissive surface (e.g., an interior of the building, car, train, bus, etc.).

As shown in the plot, a greater central patch size 415 may be associated with a greater change in a transmission phase 410 of the radio frequency wave between the first port 405-a and the second port 405-b.

In some examples, a size of the central patch of the energy-attenuating coating is correlated to a transmission phase of the radio frequency signals that propagate through the energy-attenuating laminate.

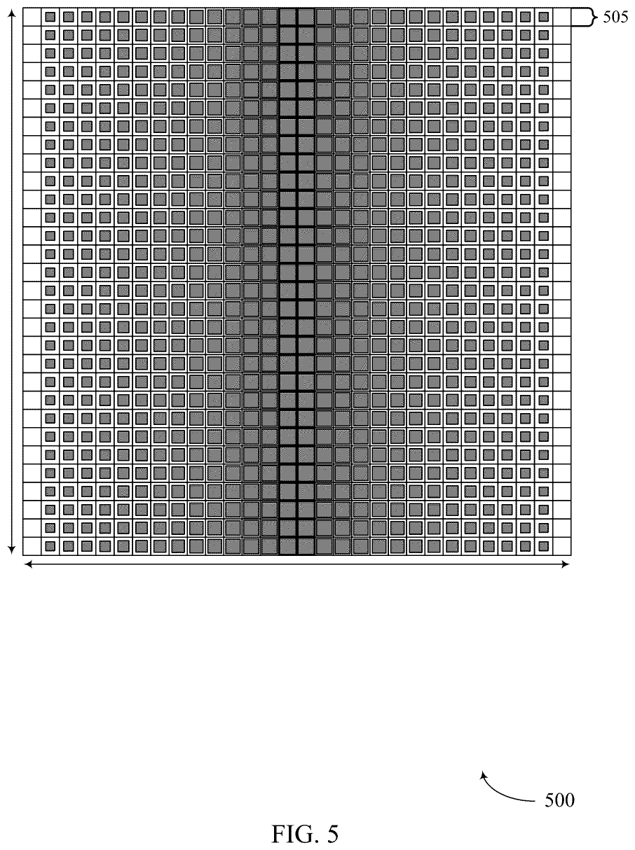

FIG. 5 shows an example of a non-uniform (etching) pattern 500 of a transmissive surface with an energy-attenuating coating in accordance with one or more aspects of the present disclosure. A non-uniform etching pattern shown in the example of FIG. 5 may be an example of a quadratic-phase transmissive surface for azimuth beam widening. The non-uniform etching pattern may be symmetric along a center line. In other words, the non-uniform etching pattern may be mirrored across a vertical line bisecting a center of the non-uniform etching pattern. The non-uniform etching pattern may be symmetric such that a radio frequency signal may be propagated symmetrically after passing through a transmissive surface including an energy-attenuating coating having the non-uniform etching pattern.

The non-uniform etching pattern may include a row of cells 505 having central patches gradually increasing at the center line. That is, a size of the central patches may increase towards a center of the non-uniform etching pattern and decrease at an edge of the non-uniform etching pattern. In some examples, the variation in the size of the central patches may be referred to as a gradient along a horizontal dimension of the non-uniform etching pattern.

In other words, the pattern of cells may include a row pattern duplicated along a vertical dimension. The row pattern may include multiple of cells having gradient widths of central patches of the energy-attenuating coating along the row pattern. A width of the central patch of the energy-attenuating coating may increase at a center of the row pattern and decreases at an edge of the row pattern.

In some examples, the non-uniform etching pattern may include 30 cells in each row and 30 cells in each column. The non-uniform etching pattern may have a total height of approximately 84 mm and a total width of approximately 84 mm. In some examples, the row pattern may be repeated 5 or more times, 10 or more times, 20 or more times, 30 or more times, etc.

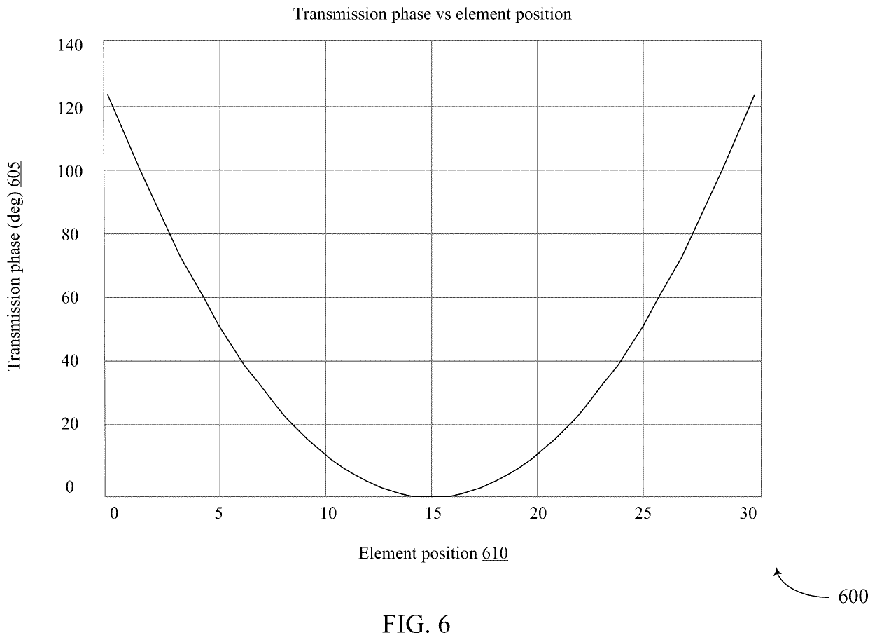

FIG. 6 shows an example of a plot 600 of a signal that may pass through a transmissive surface with an energy-attenuating coating in accordance with one or more aspects of the present disclosure. A plot shown in the example of FIG. 6 may represent a transmission phase 605 relative to an element position 610 along a horizontal dimension of the non-uniform pattern of FIG. 5. Based on the non-uniform pattern of FIG. 5 being symmetric along a vertical central line, the transmission phase 605 may also be symmetric along a central element of the non-uniform etching pattern. An element may refer to a cell of the non-uniform etching pattern in a horizontal dimension. For example, an element position “0” may refer to any cell of a row of cells along a leftmost edge of the non-uniform etching pattern.

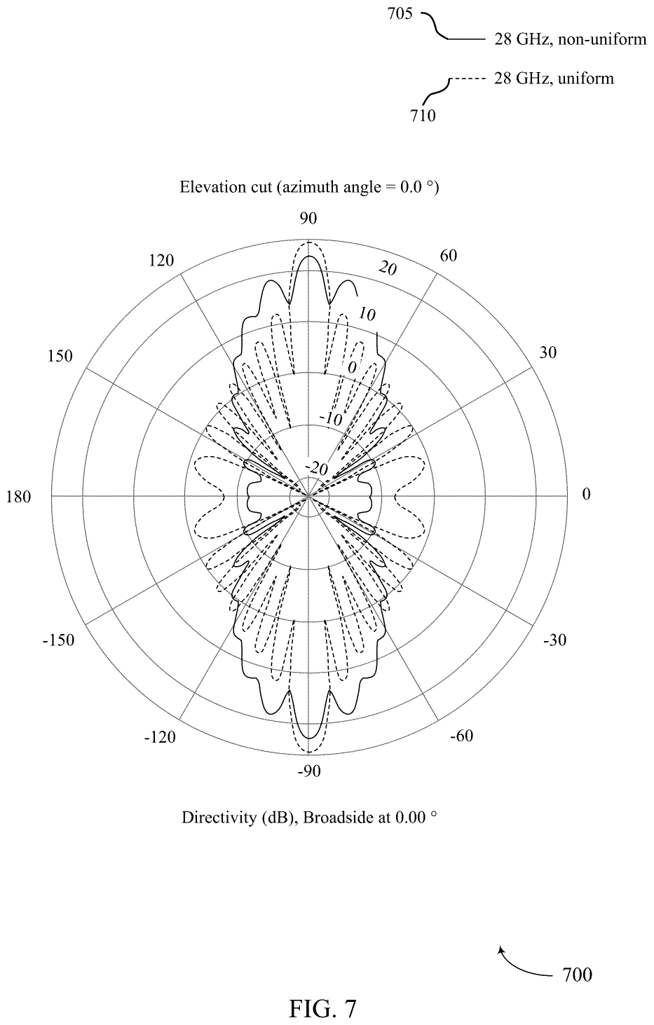

FIG. 7 shows an example of a plot 700 of a signal that may pass through a transmissive surface with an energy-attenuating coating in accordance with one or more aspects of the present disclosure. A plot shown in the example of FIG. 6 provides a polar plot of decibels relative to isotropic (dBi) for both uniform and non-uniform etching patterns. In this example, the plot includes a first outline 705 associated with the non-uniform etching pattern of FIG. 5 compared to a second outline 710 associated with a uniform etching pattern, which may be described with reference to FIG. 2. In this example, the first outline 705 is, on average, wider than the second outline 710 in an azimuth direction. For example, in a range of ±60° to ±120°, the first outline 705 is wider than the second outline 710 in the azimuth direction, where 90° is perpendicular to the transmissive surface.

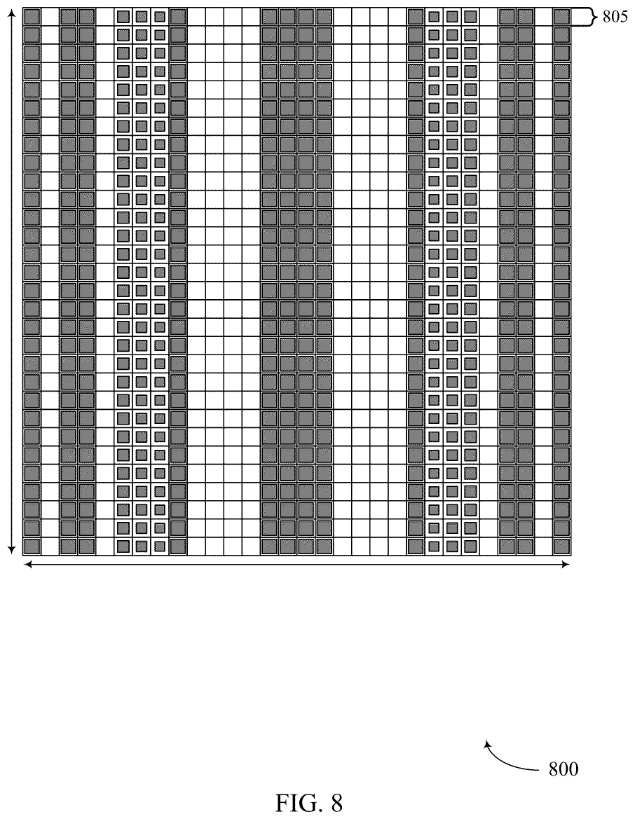

FIG. 8 shows another example of a non-uniform (etching) pattern 800 of a transmissive surface with an energy-attenuating coating in accordance with one or more aspects of the present disclosure. A non-uniform etching pattern shown in the example of FIG. 8 may be an example of a random-phase transmissive surface for azimuth beam widening. The non-uniform etching pattern may be symmetric along a center line. In other words, the non-uniform etching pattern may be mirrored across a vertical line bisecting a center of the non-uniform etching pattern. The non-uniform etching pattern may be symmetric such that a radio frequency signal may be propagated symmetrically after passing through a transmissive surface including an energy-attenuating coating having the non-uniform etching pattern.

The non-uniform etching pattern may include a row of cells 805 with alternating cells having different central patch sizes. For example, the non-uniform etching pattern may include a first cell of the row having a wide central patch; a second cell having no central patch (e.g., completely etched to reveal the substrate); third and fourth cells having the wide central patch; a fifth cell having no central patch; sixth, seventh, and eighth cells having progressively decreasing central patch sizes; a ninth cell having the wide central patch; tenth, eleventh, twelfth, and thirteenth cells having no central patch; and fourteenth and fifteenth cells having the wide central patch.

In other words, the pattern of cells may include a row pattern duplicated along a vertical dimension. The row pattern may include one or more first groups of cells having a first central patch size and one or more second groups of cells having a second central patch size smaller than the first central patch size. Respective groups of cells of the one or more first groups of cells and the one or more second groups of cells may alternate throughout the row pattern. The pattern of cells may be symmetrical across a center of the row pattern.

In some examples, the non-uniform etching pattern may include 30 cells in each row and 30 cells in each column. The non-uniform etching pattern may have a total height of approximately 84 mm and a total width of approximately 84 mm.

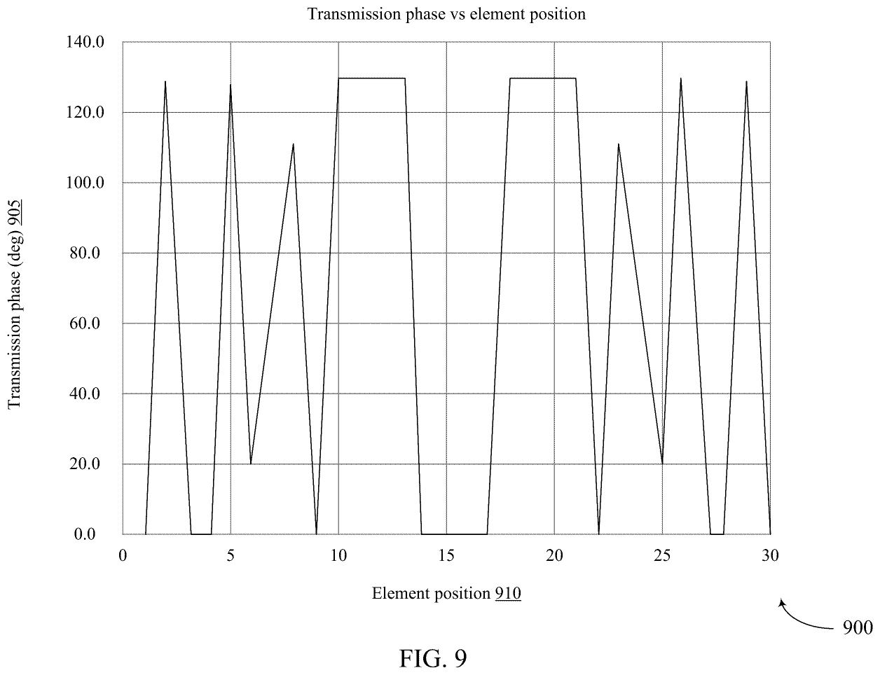

FIG. 9 shows an example of a plot 900 of a signal that may pass through a transmissive surface with an energy-attenuating coating in accordance with one or more aspects of the present disclosure. A plot shown in the example of FIG. 9 may represent a transmission phase 905 relative to an element position 910 along a horizontal dimension of the non-uniform etching pattern of FIG. 8. Based on the non-uniform etching pattern of FIG. 8 being symmetric along a vertical central line, the transmission phase may also be symmetric along a central element of the non-uniform etching pattern. An element may refer to a cell of the non-uniform etching pattern in a horizontal dimension. For example, an element position “0” may refer to any cell of a column of cells along a leftmost edge of the non-uniform etching pattern.

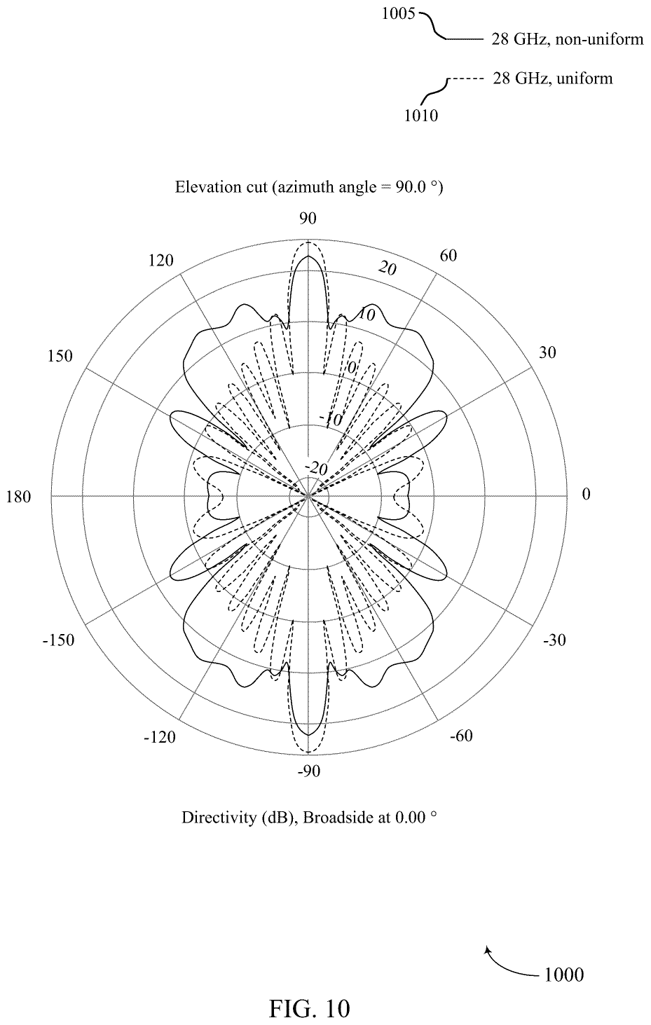

FIG. 10 shows an example of a plot 1000 of a signal that may pass through a transmissive surface with an energy-attenuating coating in accordance with one or more aspects of the present disclosure. A plot shown in the example of FIG. 10 provides a polar plot of dBi for both uniform and non-uniform etching patterns. In this example, the plot includes a first outline 1005 associated with the non-uniform etching pattern of FIG. 8 compared to a second outline 1010 associated with a uniform etching pattern, which may be described with reference to FIG. 2. In this example, the first outline 1005 is, on average, wider than the second outline 1010. For example, in a range of ±60° to ±120°, the first outline 1005 is wider than the second outline 1010.

In some examples, the non-uniform pattern may be customizable to enhance coverage of one or more wireless devices within a structure. For example, the one or more wireless devices within the structure may include a network repeater device located within a building. The non-uniform pattern may be designed to provide enhanced signal strength at the particular location of the repeater within the structure. That is, the non-uniform pattern may be designed to reduce the attenuation of the coated glass at an identified location within a structure that incorporates the coated glass, such as the location of the network repeater device within the building.

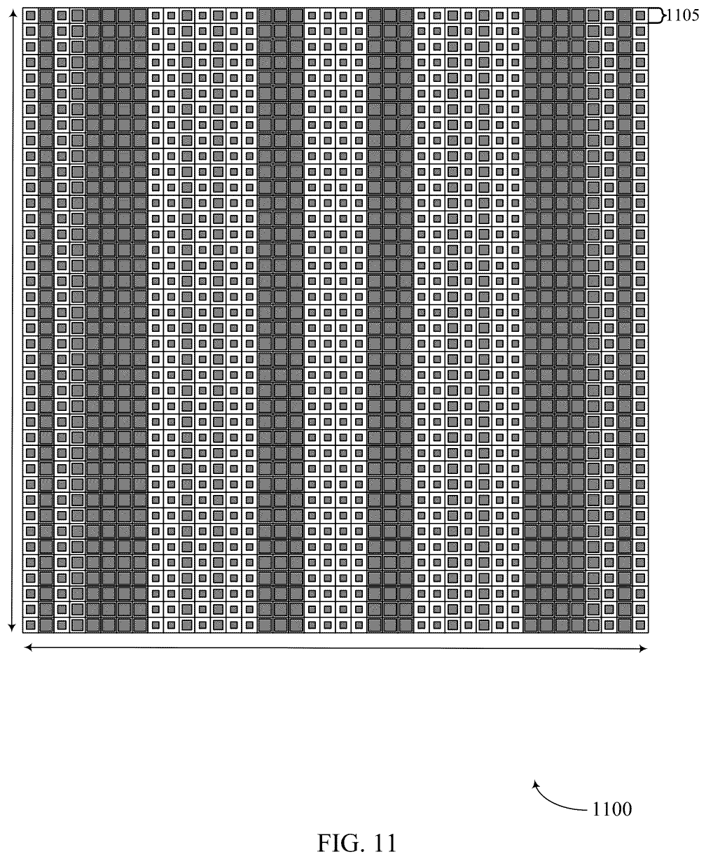

FIG. 11 shows another example of a non-uniform (etching) pattern 1100 of a transmissive surface with an energy-attenuating coating in accordance with one or more aspects of the present disclosure. A non-uniform etching pattern shown in the example of FIG. 11 may be an example of a random-phase transmissive surface for azimuth beam widening. The non-uniform etching pattern may be symmetric along a center line. In other words, the non-uniform etching pattern may be mirrored across a vertical line bisecting a center of the non-uniform etching pattern. The non-uniform etching pattern may be symmetric such that a radio frequency signal may be propagated symmetrically after passing through a transmissive surface including an energy-attenuating coating having the non-uniform etching pattern.

The non-uniform etching pattern may include a row of cells 1105 with alternating cells having different central patch sizes. The pattern of cells may include a row pattern duplicated along a vertical dimension. The row pattern may include different cells having different patch sizes. The pattern of cells may be symmetrical across a center of the row pattern.

In some examples, the non-uniform etching pattern may include 40 cells in each row and 40 cells in each column. The non-uniform etching pattern may have a total height of approximately 120 mm and a total width of approximately 120 mm.

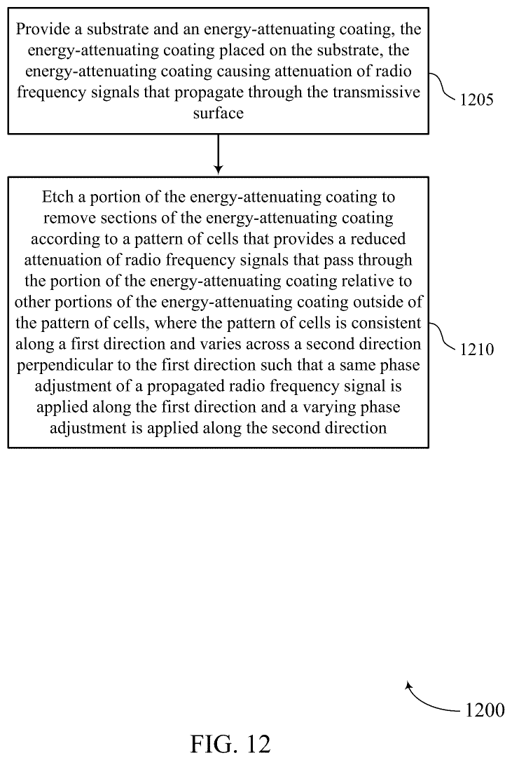

FIG. 12 shows a flowchart illustrating a method 1200 of fabricating a transmissive surface with energy-attenuating coating in accordance with one or more aspects of the present disclosure. The operations of the method 1200 may be implemented to provide a transmissive surface (e.g., an energy-attenuating laminate) or its components as described herein. For example, the operations of the method 1200 may be performed to fabricate a transmissive surface as described with reference to FIGS. 1 through 11.

At 1205, the method may include providing a substrate and an energy-attenuating coating, the energy-attenuating coating placed on the substrate, the energy-attenuating coating causing attenuation of radio frequency signals that propagate through the transmissive surface. The operations of 1205 may be performed in accordance with examples as disclosed herein. The substrate with the energy-attenuating coating may be present on a building, car, bus, train, or the like. Additionally, or alternatively, an adhesive film of the energy-attenuating coating may be applied to a glass (or other transparent) substrate. The film may, in some examples, be pre-etched in accordance with the operations of 1210 (e.g., the etching of the energy-attenuating coating).

At 1210, the method may include forming a pattern of cells with openings in a portion of the energy-attenuating coating on the substrate, wherein the pattern of cells with openings reduces attenuation of radio frequency signals propagating through the portion relative to another portion of the energy-attenuating coating that is provided without openings, where the pattern of cells is provided along a first direction with cells having uniform sizes and shapes and provided along a second direction perpendicular to the first direction with cells having varying sizes and/or shapes such that a propagated radio frequency signal experiences varying phase adjustment across the pattern of cells in the second direction. The operations of 1210 may be performed in accordance with examples as disclosed herein.

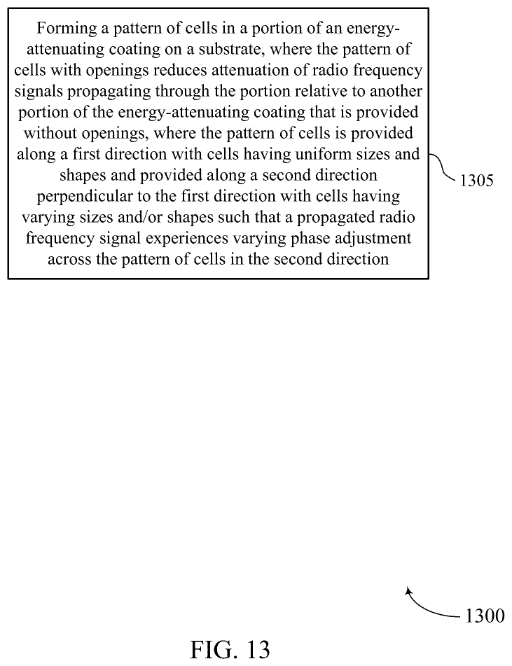

FIG. 13 shows a flowchart illustrating a method 1300 of forming a transmissive surface with energy-attenuating coating in accordance with one or more aspects of the present disclosure. The operations of the method 1300 may be implemented to provide an energy-attenuating laminate or its components as described herein. For example, the operations of the method 1300 may be performed to fabricate an energy-attenuating laminate as described with reference to FIGS. 1 through 11.

At 1305, the method may include forming a pattern of cells with openings in a portion of an energy-attenuating coating on a substrate, where the pattern of cells with openings reduces attenuation of radio frequency signals propagating through the portion relative to another portion of the energy-attenuating coating that is provided without openings, where the pattern of cells is provided along a first direction with cells having uniform sizes and shapes and provided along a second direction perpendicular to the first direction with cells having varying sizes and/or shapes such that a propagated radio frequency signal experiences varying phase adjustment across the pattern of cells in the second direction. The operations of 1305 may be performed in accordance with examples as disclosed herein. The substrate with the energy-attenuating coating may be present on a building, car, bus, train, or the like. Additionally, or alternatively, an adhesive film of the energy-attenuating coating may be applied to a glass (or other transparent) substrate. The film may, in some examples, be pre-etched in accordance with the operations of 1210 (e.g., the etching of the energy-attenuating coating).

The following provides an overview of aspects of the present disclosure:

Aspect 1: A method for forming a transmissive surface, comprising: forming a pattern of cells with openings in a portion of an energy-attenuating coating on a substrate, wherein the pattern of cells with openings reduces attenuation of radio frequency signals propagating through the portion relative to another portion of the energy-attenuating coating that is provided without openings, wherein the pattern of cells is provided along a first direction with cells having uniform sizes and shapes and provided along a second direction perpendicular to the first direction with cells having varying sizes or shapes such that a propagated radio frequency signal experiences varying phase adjustment across the pattern of cells in the second direction.

Aspect 2: The method of aspect 1, wherein forming the pattern of cells comprises: etching the portion of the energy-attenuating coating to remove sections of the energy-attenuating coating according to the pattern of cells.

Aspect 3: The method of any of aspects 1 through 2, wherein the pattern of cells comprises a row of cells duplicated along the first direction, the row comprising: a plurality of cells having varying outline widths, varying central patch sizes, or both of the energy-attenuating coating along the row, wherein the outline widths, the central patch sizes, or both of the energy-attenuating coating increases at a center of the row relative to an edge of the row.

Aspect 4: The method of any of aspects 1 through 3, wherein the pattern of cells comprises a row of cells duplicated along the first direction, the row comprising: one or more first groups of cells having a first outline width, a first central patch size, or both; and one or more second groups of cells having a second outline width smaller than the first outline width, a second central patch size smaller than the first central patch size, or both, wherein respective groups of cells of the one or more first groups of cells and the one or more second groups of cells alternate across the row, and wherein the pattern of cells is symmetrical to a center of the row.

Aspect 5: The method of any of aspects 1 through 4, wherein each cell of the pattern of cells comprises an outline of the energy-attenuating coating, a central patch of the energy-attenuating coating, or both.

Aspect 6: The method of aspect 5, wherein a size of the central patch of the energy-attenuating coating in the one or more first groups and the one or more second groups is equal to or less than half of a wavelength associated with an incident beam of the radio frequency signals that propagate through the transmissive surface.

Aspect 7: The method of any of aspects 5 through 6, wherein a width of an opening between the outline of the energy-attenuating coating and the central patch of the energy-attenuating coating is non-uniform across the pattern in the second direction.

Aspect 8: The method of aspect 7, wherein the width of the opening between the outline of the energy-attenuating coating and the central patch of energy-attenuating coating in the one or more first groups and the one or more second groups is between approximately 3/160 and 15/160 of a wavelength associated with an incident beam of the radio frequency signals that propagate through the transmissive surface.

Aspect 9: The method of any of aspects 1 through 8, wherein a total width and a total height of the portion comprising the pattern of cells is approximately 4 or more times larger than a wavelength associated with an incident beam of the radio frequency signals that propagate through the transmissive surface.

Aspect 10: The method of any of aspects 1 through 9, wherein the pattern of cells is selected such that a radiation beam of the radio frequency signals that propagate through the transmissive surface has the reduced attenuation at a location within a structure that incorporates the transmissive surface.

Aspect 11: The method of any of aspects 1 through 10, wherein the substrate comprises a first substrate of a plurality of substrates, and the energy-attenuating coating comprises a first energy-attenuating coating of a plurality of energy-attenuating coatings corresponding to each substrate of the plurality of substrates.

Aspect 12: The method of any of aspects 1 through 11, wherein two or more patterned energy-attenuating coatings are located on a same side of the substrate.

Aspect 13: The method of any of aspects 1 through 12, wherein the energy-attenuating coating comprises a first energy-attenuating coating of a plurality of energy-attenuating coatings, the method further comprising: providing a second energy-attenuating coating located on a side of the substrate opposite the first energy-attenuating coating.

Aspect 14: The method of any of aspects 1 through 13, wherein the pattern of cells provides a radiation beam shape of the radio frequency signals that propagate through the transmissive surface, a radiation beam position of the radio frequency signals that propagate through the transmissive surface, or both, associated with a first shape, the first shape being different than a second shape associated with a uniform pattern of cells in the energy-attenuating coating.

Aspect 15: An apparatus for forming a transmissive surface, comprising one or more memories storing processor-executable code, and one or more processors coupled with the one or more memories and individually or collectively operable to execute the code to cause the apparatus to perform a method of any of aspects 1 through 14.

Aspect 16: An apparatus for forming a transmissive surface, comprising at least one means for performing a method of any of aspects 1 through 14.

Aspect 17: A non-transitory computer-readable medium storing code for forming a transmissive surface, the code comprising instructions executable by one or more processors to perform a method of any of aspects 1 through 14.

Aspect 18: An transmissive surface, comprising: an energy-attenuating coating provided on a substrate, the energy-attenuating coating causing an attenuation of radio frequency signals that propagate through the transmissive surface, wherein a portion of the energy-attenuating coating is provided with a pattern of cells with openings that reduces attenuation of radio frequency signals propagating through the portion relative to another portion of the energy-attenuating coating that is provided without openings, and wherein: the pattern of cells is provided along a first direction with cells having uniform sizes and shapes and provided along a second direction perpendicular to the first direction with cells having varying sizes or shapes such that a propagated radio frequency signal experiences a varying phase adjustment across the pattern of cells in the second direction.

Aspect 19: The transmissive surface of aspect 18, wherein the pattern of cells comprises a row of cells duplicated along the first direction, the row comprising: a plurality of cells having varying outline widths, varying central patch sizes, or both of the energy-attenuating coating across the row, wherein the outline widths, the central patch sizes, or both of the energy-attenuating coating increase at a center of the row relative to an edge of the row.

Aspect 20: The transmissive surface of any of aspects 18 through 19, wherein the pattern of cells comprises a row of cells duplicated along the first direction, the row pattern comprising: one or more first groups of cells having a first outline width, a first central patch size, or both; and one or more second groups of cells having a second outline width smaller than the first outline width, a second central patch size smaller than the first central patch size, or both, wherein respective groups of cells of the one or more first groups of cells and the one or more second groups of cells alternate across the row, and wherein the pattern of cells is symmetrical to a center of the row.

Aspect 21: The transmissive surface of any of aspects 18 through 20, wherein each cell of the pattern of cells comprises an outline of the energy-attenuating coating, a central patch of the energy-attenuating coating, or both.

Aspect 22: The transmissive surface of aspect 21, wherein a size of the central patch of the energy-attenuating coating is equal to or less than half of a wavelength associated with the radio frequency signals that propagate through the transmissive surface.

Aspect 23: The transmissive surface of any of aspects 21 through 22, wherein a width of an opening between the outline of the energy-attenuating coating and the central patch of the energy-attenuating coating is non-uniform across the pattern in the second direction.

Aspect 24: The transmissive surface of any of aspects 21 through 23, wherein the width of the opening between the outline of the energy-attenuating coating and the central patch of the energy-attenuating coating is between approximately 3/160 and 15/160 of a wavelength associated with an incident beam of the radio frequency signals that propagate through the transmissive surface.

Aspect 25: The transmissive surface of any of aspects 21 through 24, wherein a size of the central patch of the energy-attenuating coating is correlated to a transmission phase of the radio frequency signals that propagate through the transmissive surface.

Aspect 26: The transmissive surface of any of aspects 18 through 25, wherein a total width and a total height of the portion comprising the pattern of cells is 4 or more times larger than a wavelength associated with the radio frequency signals that propagate through the transmissive surface.

Aspect 27: The transmissive surface of any of aspects 18 through 26, wherein the pattern of cells is selected such that the radio frequency signals that propagate through the transmissive surface have reduced attenuation at an identified location within a structure that incorporates the transmissive surface.

Aspect 28: The transmissive surface of any of aspects 18 through 27, the substrate comprises a first substrate of a plurality of substrates, and the energy-attenuating coating comprises a first energy-attenuating coating of a plurality of energy-attenuating coatings corresponding to each substrate of the plurality of substrates.

Aspect 29: The transmissive surface of any of aspects 18 through 28, wherein two or more patterned energy-attenuating coatings are located on a same side of the substrate.

Aspect 30: The transmissive surface of any of aspects 18 through 29, wherein the energy-attenuating coating comprises a first energy-attenuating coating of a plurality of energy-attenuating coatings, the transmissive surface further comprising: a second energy-attenuating coating located on a side of the substrate opposite the first energy-attenuating coating.

Aspect 31: The transmissive surface of any of aspects 18 through 30, wherein the transmissive surface is separate from an entity from which the radio frequency signals are transmitted.

Aspect 32: The transmissive surface of any of aspects 18 through 31, wherein the pattern of cells provides a radiation beam shape of the radio frequency signals that propagate through the transmissive surface, a radiation beam position of the radio frequency signals that propagate through the transmissive surface, or both, associated with a first shape, the first shape being different than a second shape associated with a uniform pattern of cells in the energy-attenuating coating.

It should be noted that the methods described herein describe possible implementations. The operations and the steps may be rearranged or otherwise modified and other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A transmissive surface, comprising:
an energy-attenuating coating provided on a substrate, the energy-attenuating coating causing an attenuation of radio frequency signals that propagate through the transmissive surface, wherein a portion of the energy-attenuating coating is provided with a pattern of cells with openings that reduces attenuation of radio frequency signals propagating through the portion relative to another portion of the energy-attenuating coating that is provided without openings, and wherein:
the pattern of cells is provided along a first direction with cells having uniform sizes and shapes and provided along a second direction perpendicular to the first direction with cells having varying sizes or shapes such that a propagated radio frequency signal experiences a varying phase adjustment across the pattern of cells in the second direction.

2. The transmissive surface of claim 1, wherein the pattern of cells comprises a row of cells duplicated along the first direction, the row comprising:
a plurality of cells having varying outline widths, varying central patch sizes, or both of the energy-attenuating coating across the row, wherein the outline widths, the central patch sizes, or both of the energy-attenuating coating increase at a center of the row relative to an edge of the row.

3. The transmissive surface of claim 1, wherein the pattern of cells comprises a row of cells duplicated along the first direction, the row comprising:
one or more first groups of cells having a first outline width, a first central patch size, or both; and
one or more second groups of cells having a second outline width smaller than the first outline width, a second central patch size smaller than the first central patch size, or both, wherein respective groups of cells of the one or more first groups of cells and the one or more second groups of cells alternate across the row, and wherein the pattern of cells is symmetrical to a center of the row.

4. The transmissive surface of claim 1, wherein each cell of the pattern of cells comprises an outline of the energy-attenuating coating, a central patch of the energy-attenuating coating, or both.

5. The transmissive surface of claim 4, wherein a size of the central patch of the energy-attenuating coating is equal to or less than half of a wavelength associated with the radio frequency signals that propagate through the transmissive surface.

6. The transmissive surface of claim 4, wherein a width of an opening between the outline of the energy-attenuating coating and the central patch of the energy-attenuating coating is non-uniform across the pattern in the second direction.

7. The transmissive surface of claim 6, wherein the width of the opening between the outline of the energy-attenuating coating and the central patch of the energy-attenuating coating is between approximately 3/160 and 15/160 of a wavelength associated with an incident beam of the radio frequency signals that propagate through the transmissive surface.

8. The transmissive surface of claim 1, wherein a total width and a total height of the portion comprising the pattern of cells is 4 or more times larger than a wavelength associated with the radio frequency signals that propagate through the transmissive surface.

9. The transmissive surface of claim 1, wherein the pattern of cells is selected such that the radio frequency signals that propagate through the transmissive surface have reduced attenuation at an identified location within a structure that incorporates the transmissive surface.

10. The transmissive surface of claim 1, wherein:
the substrate comprises a first substrate of a plurality of substrates, and
the energy-attenuating coating comprises a first energy-attenuating coating of a plurality of energy-attenuating coatings corresponding to each substrate of the plurality of substrates.

11. The transmissive surface of claim 1, wherein two or more patterned energy-attenuating coatings are located on a same side of the substrate.

12. The transmissive surface of claim 1, wherein the energy-attenuating coating comprises a first energy-attenuating coating of a plurality of energy-attenuating coatings, the transmissive surface further comprising:
a second energy-attenuating coating located on a side of the substrate opposite the first energy-attenuating coating.

13. The transmissive surface of claim 1, wherein the pattern of cells provides a radiation beam shape of the radio frequency signals that propagate through the transmissive surface, a radiation beam position of the radio frequency signals that propagate through the transmissive surface, or both, associated with a first shape, the first shape being different than a second shape associated with a uniform pattern of cells in the energy-attenuating coating.

14. A method for forming a transmissive surface, comprising:
forming a pattern of cells with openings in a portion of an energy-attenuating coating on a substrate, wherein the pattern of cells with openings reduces attenuation of radio frequency signals propagating through the portion relative to another portion of the energy-attenuating coating that is provided without openings, wherein:
the pattern of cells is provided along a first direction with cells having uniform sizes and shapes and provided along a second direction perpendicular to the first direction with cells having varying sizes or shapes such that a propagated radio frequency signal experiences varying phase adjustment across the pattern of cells in the second direction.

15. The method of claim 14, wherein forming the pattern of cells comprises:
etching the portion of the energy-attenuating coating to remove sections of the energy-attenuating coating according to the pattern of cells.

16. The method of claim 14, wherein the pattern of cells comprises a row of cells duplicated along a vertical dimension, the row comprising:
a plurality of cells having varying outline widths, varying central patch sizes, or both of the energy-attenuating coating across the row, wherein the outline widths, the central patch sizes, or both of the energy-attenuating coating increases at a center of the row relative to an edge of the row.

17. The method of claim 14, wherein the pattern of cells comprises a row of cells duplicated along the first direction, the row comprising:
one or more first groups of cells having a first outline width, a first central patch size, or both; and
one or more second groups of cells having a second outline width smaller than the first outline width, a second central patch size smaller than the first central patch size, or both, wherein respective groups of cells of the one or more first groups of cells and the one or more second groups of cells alternate across the row, and wherein the pattern of cells is symmetrical to a center of the row.

18. The method of claim 17, wherein a size of the central patch of the energy-attenuating coating in the one or more first groups and the one or more second groups is equal to or less than half of a wavelength associated with the radio frequency signals that propagate through the transmissive surface.

19. The method of claim 17, wherein the width of the opening between the outline of the energy-attenuating coating and the central patch of energy-attenuating coating in the one or more first groups and the one or more second groups is between approximately 3/160 and 15/160 of a wavelength associated with an incident beam of the radio frequency signals that propagate through the transmissive surface.

20. The method of claim 14, wherein a total width and a total height of the portion comprising the pattern of cells is 4 or more times larger than a wavelength associated with the radio frequency signals that propagate through the transmissive surface.
